(19) United States
(12) Patent Application Publication
(10) Pub. No.: US 2005/0071566 A1
(43) Pub. Date: Mar. 31, 2005

(54) Mechanism to increase data compression in a cache

(76) Inventors: Ali-Reza Adl-Tabatabai, Santa Clara, CA (US); Anwar M. Ghuloum, Mountain View, CA (US); Eric Sprangle, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/676,478

(22) Filed: Sep. 30, 2003

(51) Int. Cl. G06F 12/00

(52) U.S. Cl. 711/128

(57) ABSTRACT

According to one embodiment a computer system is disclosed. The computer system includes a central processing unit (CPU) and a cache memory coupled to the CPU. The cache memory includes a main cache having plurality of compressible cache lines to store additional data, and a plurality of storage pools to hold a segment of the additional data for one or more of the plurality of cache lines that are to be compressed.

### FIELD OF THE INVENTION

The present invention relates to computer systems; more particularly, the present invention relates to central processing unit (CPU) caches.

### BACKGROUND

Currently, various methods are employed to compress the content of computer system main memories such as Random Access Memory. (RAM). These methods decrease the amount of physical memory space needed to provide the same performance. For instance, if a memory is compressed using a 2:1 ratio, the memory may store twice the amount of data at the same cost, or the same amount of data at half the cost.

One such method is Memory Expansion Technology (MXT), developed by International Business Machines (IBM) of Armonk, N.Y. MXT addresses system memory costs with a memory system architecture that doubles the effective capacity of the installed main memory. Logic-intensive compressor and decompressor hardware engines provide the means to simultaneously compress and decompress data as it is moved between the shared cache and the main memory. The compressor encodes data blocks into as compact a result as the algorithm permits.

However, there is currently no method for compressing data that is stored in a cache. Having the capability to compress cache data would result in similar advantages as main memory compression (e.g., decreasing the amount of cache space needed to provide the same performance).

### BRIEF DESCRIPTION OF THE DRAWINGS

The present invention will be understood more fully from the detailed description given below and from the accompanying drawings of various embodiments of the invention. The drawings, however, should not be taken to limit the invention to the specific embodiments, but are for explanation and understanding only.

FIG. 1 illustrates one embodiment of a computer system;

FIG. 2 illustrates one embodiment of a physical cache organization;

FIG. 3 illustrates one embodiment of a logical cache organization;

FIG. 4A illustrates an exemplary memory address implemented in an uncompressed cache;

FIG. 4B illustrates one embodiment of a memory address implemented in a compressed cache;

FIG. 5 illustrates one embodiment of a tag array entry for a compressed cache;

FIG. 6 is a block diagram illustrating one embodiment of a cache controller;

FIG. 7 illustrates one embodiment of a set and way selection mechanism in a compressed cache;

FIG. 8 illustrates one embodiment of tag comparison logic;

FIG. 9 illustrates another embodiment of a tag array entry for a compressed cache;

FIG. 10 illustrates another embodiment of tag comparison logic;

FIG. 11 illustrates one embodiment of byte selection logic;

FIG. 12 illustrates one embodiment of a pool of bytes cache;

FIG. 13 illustrates another embodiment of a pool of bytes cache;

FIG. 14 illustrates yet another embodiment of a pool of bytes cache;

FIG. 15 illustrates one embodiment of a cache lookup scheme; and

FIG. 16 illustrates another embodiment of a cache lookup scheme.

### DETAILED DESCRIPTION

A mechanism for compressing data in a cache is described. In the following description, numerous details are set forth. It will be apparent, however, to one skilled in the art, that the present invention may be practiced without these specific details. In other instances, well-known structures and devices are shown in block diagram form, rather than in detail, in order to avoid obscuring the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

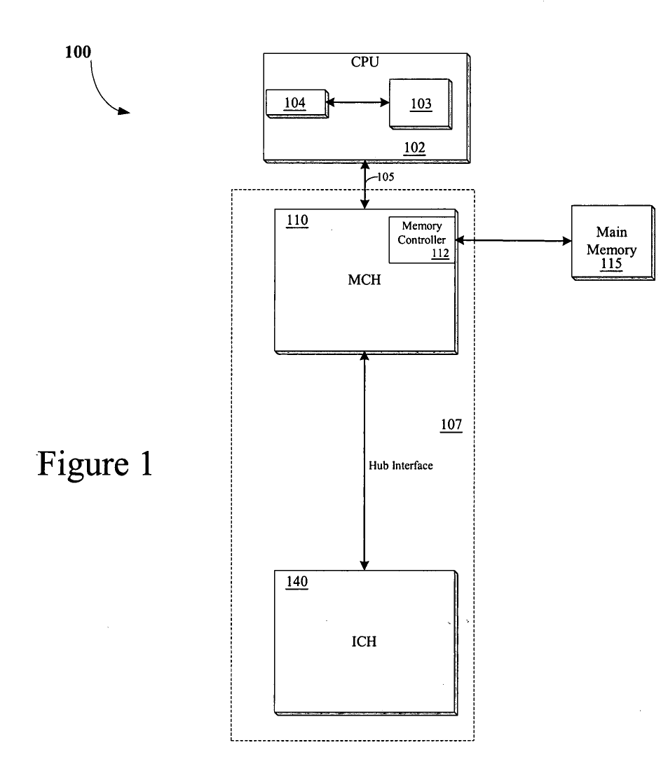

FIG. 1 is a block diagram of one embodiment of a computer system 100. Computer system 100 includes a central processing unit (CPU) 102 coupled to bus 105. In one embodiment, CPU 102 is a processor in the Pentium® family of processors including the Pentium® II processor family, Pentium® III processors, and Pentium® IV processors available from Intel Corporation of Santa Clara, Calif. Alternatively, other CPUs may be used.

A chipset 107 is also coupled to bus 105. Chipset 107 includes a memory control hub (MCH) 110. MCH 110 may include a memory controller 112 that is coupled to a main system memory 115. Main system memory 115 stores data and sequences of instructions and code represented by data signals that may be executed by CPU 102 or any other device included in system 100.

In one embodiment, main system memory 115 includes dynamic random access memory (DRAM); however, main system memory 115 may be implemented using other memory types. Additional devices may also be coupled to bus 105, such as multiple CPUs and/or multiple system memories.

In one embodiment, MCH 110 is coupled to an input/output control hub (ICH) 140 via a hub interface. ICH 140 provides an interface to input/output (I/O) devices within computer system 100. For instance, ICH 140 may be coupled to a Peripheral Component Interconnect bus adhering to a. Specification Revision 2.1 bus developed by the PCI Special Interest Group of Portland, Oreg.

According to one embodiment, a cache memory 103 resides within processor 102 and stores data signals that are also stored in memory 115. Cache 103 speeds up memory accesses by processor 103 by taking advantage of its locality of access. In another embodiment, cache 103 resides external to processor 103.

Compressed Cache

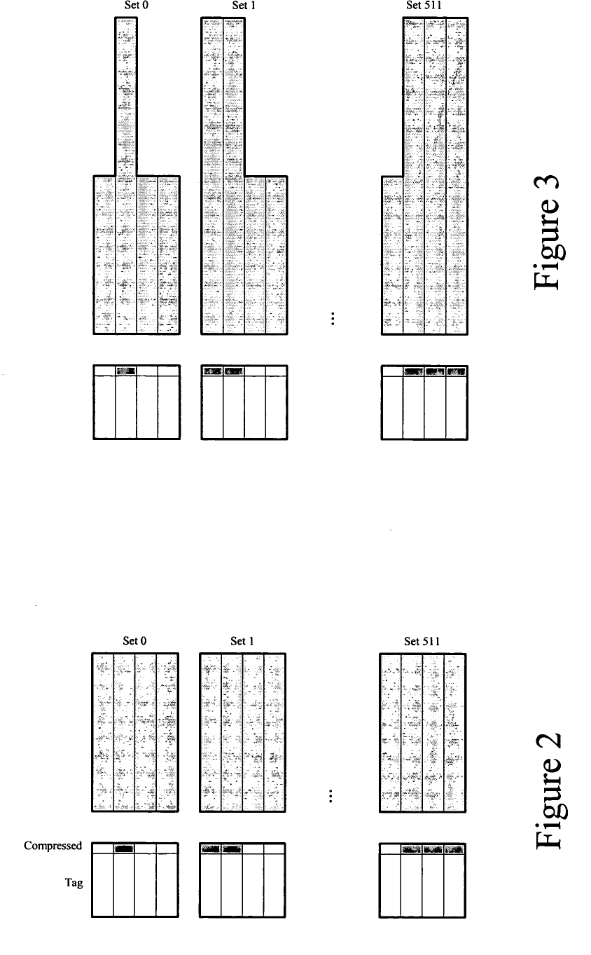

According to one embodiment, cache 103 includes compressed cache lines to enable the storage of additional data within the same amount of area. FIG. 2 illustrates one embodiment of a physical organization for cache 103. In one embodiment, cache 103 is a 512 set, 4-way set associative cache. However, one of ordinary skill in the art will appreciate that caches implementing other sizes may be implemented without departing from the true scope of the invention.

A tag is associated with each line of a set. Moreover, a compression bit is associated with each tag. The compression bits indicate whether a respective cache line holds compressed data. When a compression bit is set, the physical memory of the cache line holds two compressed companion lines. Companion lines are two lines with addresses that differ only in the companion bit (e.g., two consecutive memory lines aligned at line alignment).

In one embodiment, the companion bit is selected so that companion lines are adjacent lines. However, any bit can be selected to be the companion bit. In other embodiments, it may be possible to encode the compression indication with other bits that encode cache line state, such as the MESI state bits, thus eliminating this space overhead altogether.

When the compression bit is not set, the physical memory of the cache line holds one line uncompressed. Shaded compression bits in FIG. 2 illustrate compressed cache lines. FIG. 3 illustrates one embodiment of a logical organization for cache 103. As shown in FIG. 3, cache lines are compressed according to a 2:1 compression scheme. For example, the second line of set 0 is compressed, thus storing two cache lines rather than one.

In one embodiment, each cache line holds 64 bytes of data when not compressed. Thus, each cache line holds 128 bytes of data when compressed. The effect of the described compression scheme is that each cache tag maps to a variable-length logical cache line. As a result, cache 103 may store twice the amount of data without having to increase in physical size.

Referring back to FIG. 1, a cache controller 104 is coupled to cache 103 to manage the operation of cache 103. Particularly, cache controller 104 performs lookup operations of cache 103. According to one embodiment, the hashing function that is used to map addresses to physical sets and ways is modified from that used in typical cache controllers. In one embodiment, the hashing function is organized so that companion lines map to the same set. Consequently, companion lines may be compressed together into a single line (e.g., way) that uses one address tag.

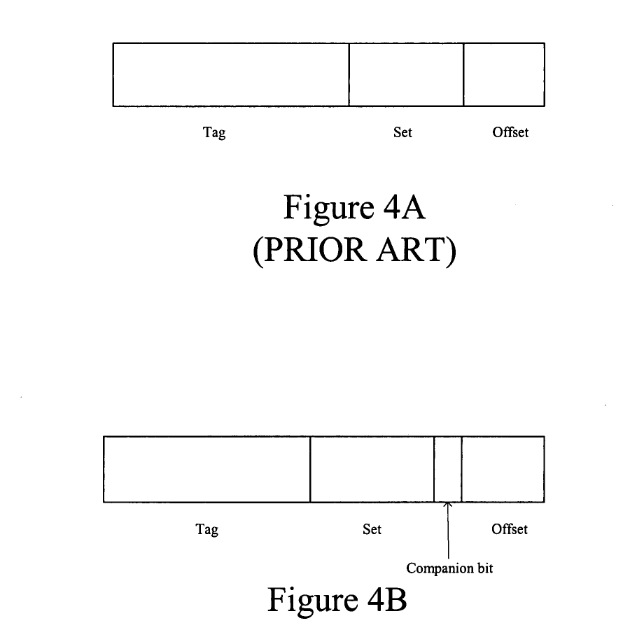

FIG. 4A illustrates an exemplary memory address implemented in an uncompressed cache. In a traditional cache, an addressed is divided according to tag, set and offset components. The set component is used to select one of the sets of lines. Similarly, the offset component is the low order bits of the address that are used to select bytes within a line.

FIG. 4B illustrates one embodiment of a memory address implemented for lookup in a compressed cache. FIG. 4B shows the implementation of a companion bit used to map companion lines into the same set. The companion bit is used in instances where a line is not compressed. Accordingly, if a line is not compressed, the companion bit indicates which of the adjacent lines are to be used.

In a traditional uncompressed cache, the companion bit is a part of the address and is used in set selection to determine whether an address hashes to an odd or even cache set. In one embodiment, the window of address bits that are used for set selection is shifted to the left by one so that the companion bit lies between the set selection and byte offset bits. In this way, companion lines map to the same cache set since the companion bit and set selection bits do not overlap. The companion bit, which now is no longer part of the set selection bits, becomes part of the tag, though the actual tag size does not increase.

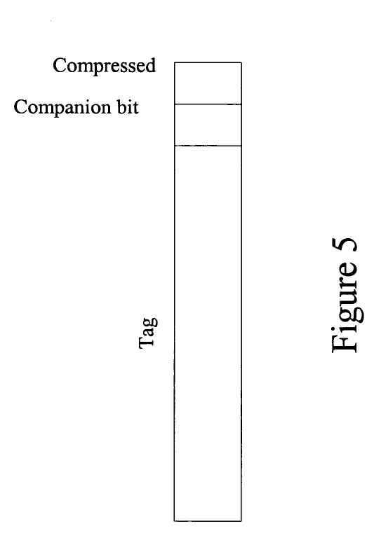

FIG. 5 illustrates one embodiment of a tag array entry for a compressed cache. The tag array entries include the companion bit (e.g., as part of the address tag bits) and a compression bit. The compression bit causes the compressed cache 103 tag to be one bit larger than a traditional uncompressed cache's tag. The compression bit indicates whether a line is compressed.

Particularly, the compression bit specifies how to deal with the companion bit. If the compression bit indicates a line is compressed, the companion bit is treated as a part of the offset because the line is a compressed pair. If the compression bit indicates no compression, the companion bit is considered as a part of the tag array and ignored as a part of the offset.

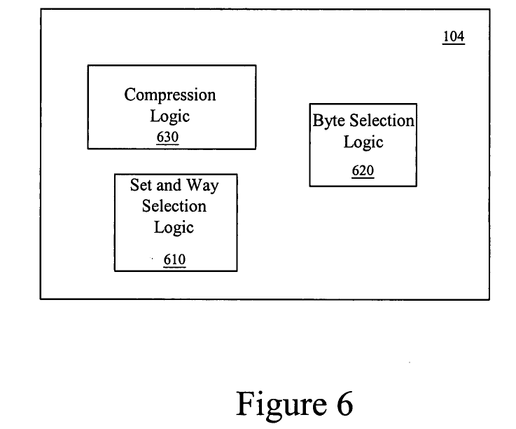

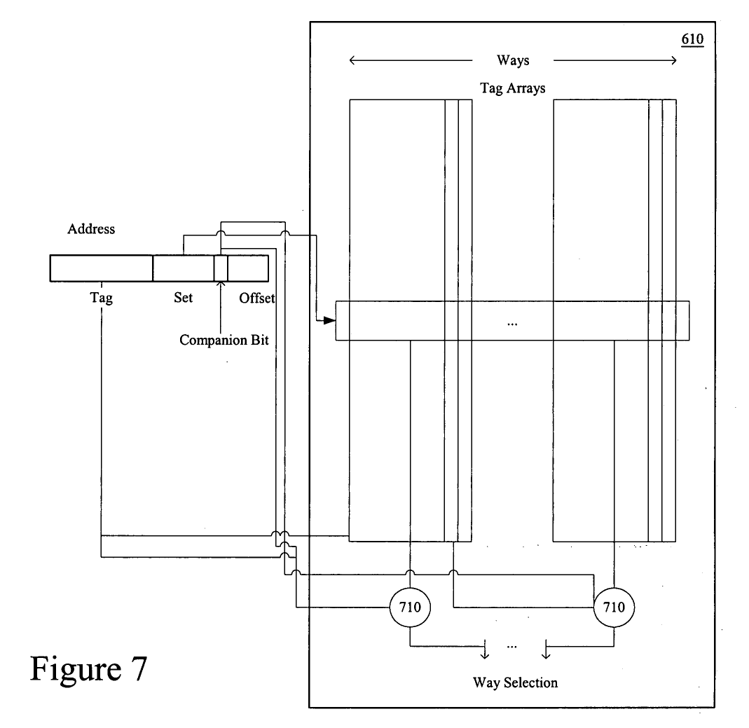

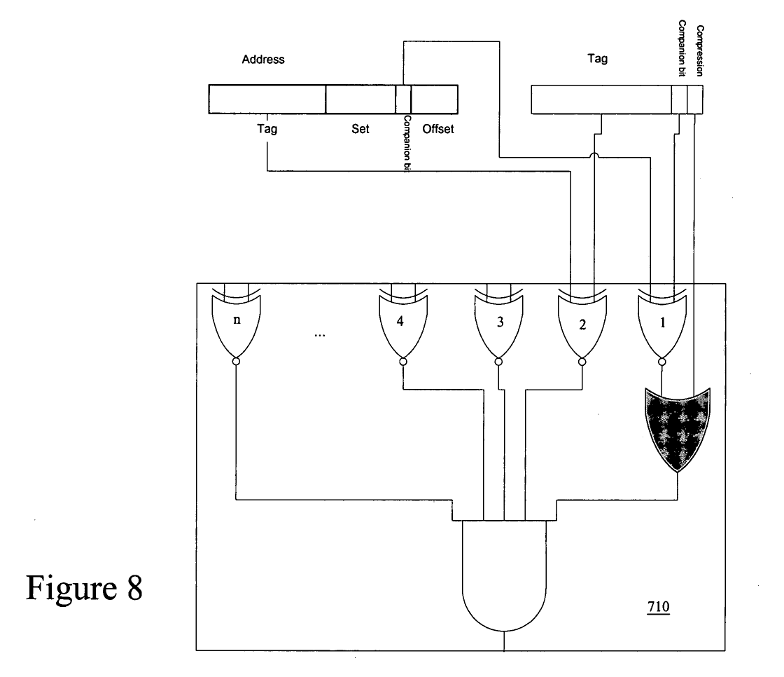

FIG. 6 is a block diagram illustrating one embodiment of cache controller 104. Cache controller 104 includes set and way selection logic 610, byte selection logic 620 and compression logic 630. Set and way selection logic 610 is used to select cache lines within cache 103. FIG. 7 illustrates one embodiment of set and way selection logic 610 in a compressed cache.

Referring to FIG. 7, set and way selection logic 610 includes tag comparison logic 710 that receives input from a tag array to select a cache line based upon a received address. The tag comparison logic 710 takes into account whether a cache line holds compressed data. Because cache lines hold a variable data size, tag comparison logic 710 is also variable length, depending on whether a particular line is compressed or not. Therefore, the tag match takes into account the compression bit.

FIG. 8 illustrates one embodiment of tag comparison logic 710 includes exclusive-nor (XNOR) gates 1-n, an OR gate and an AND gate. The XNOR gates and the AND gate is included in traditional uncompressed caches, and are used to compare the address with tag entries in the tag array until a match is found. The OR gate is used to select the companion bit depending upon the compression state of a line.

The companion bit of the address is selectively ignored depending on whether the compression bit is set. As discussed above, if the compression bit is set, the companion bit of the address is ignored during tag match because the cache line contains both companions. If the compression bit is not set, the companion bit of the address is compared with the companion bit of the tag.

The “Product of XNOR” organization of the equality operator, therefore, uses the OR gate to selectively ignore the companion bit. In one embodiment, because the tag's companion bit is ignored when the compression bit is set (e.g., it is a “don't care”), the tag's companion bit can be used for other uses. For example, when a line is compressed, this bit may be used as a compression format bit to select between two different compression algorithms. In another example, the companion bit can be used to encode the ordering of companion lines in the compressed line.

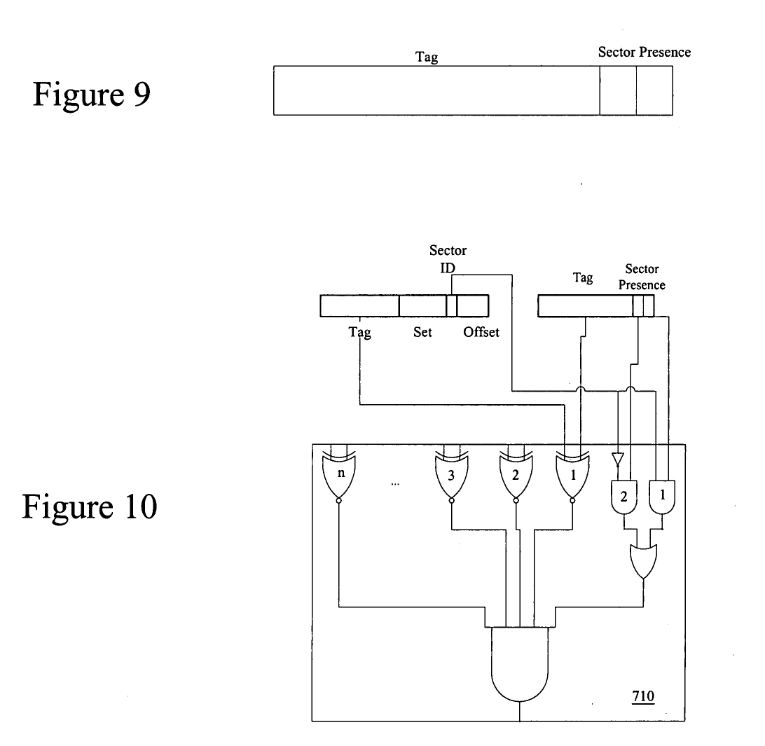

In other embodiments, each cache line is partitioned into two sectors that are stored in the same physical cache line only if the sectors can be compressed together. In the tag entry, the companion and compression bits become sector presence indications, as illustrated in FIG. 9. In this embodiment, the companion bit is a sector identifier (e.g., upper or lower) and thus has been relabeled as sector ID.

Accordingly, a “01” indicates a lower sector (not compressed), “10” indicates an upper sector (not compressed), and a “11” indicates both sectors (2:1 compression). Also, in this arrangement the physical cache line size is the same as the logical sector size. When uncompressed, each sector of a line is stored in a different physical line within the same set (e.g., different ways of the same set).

When compressible by at least 2:1, the two sectors of each line are stored in a single physical cache line (e.g., in one way). It is important to note that this differs from traditional sectored cache designs in that different logical sectors of a given logical line may be stored simultaneously in different ways when uncompressed.

In one embodiment, a free encoding (“00”) is used to indicate an invalid entry, potentially reducing the tag bit cost if combined with other bits that encode the MESI state. Because this is simply an alternative encoding, the sector presence bits require slightly difference logic to detect tag match. FIG. 10 illustrates another embodiment of tag comparison logic 610 implementing sector presence encoding.

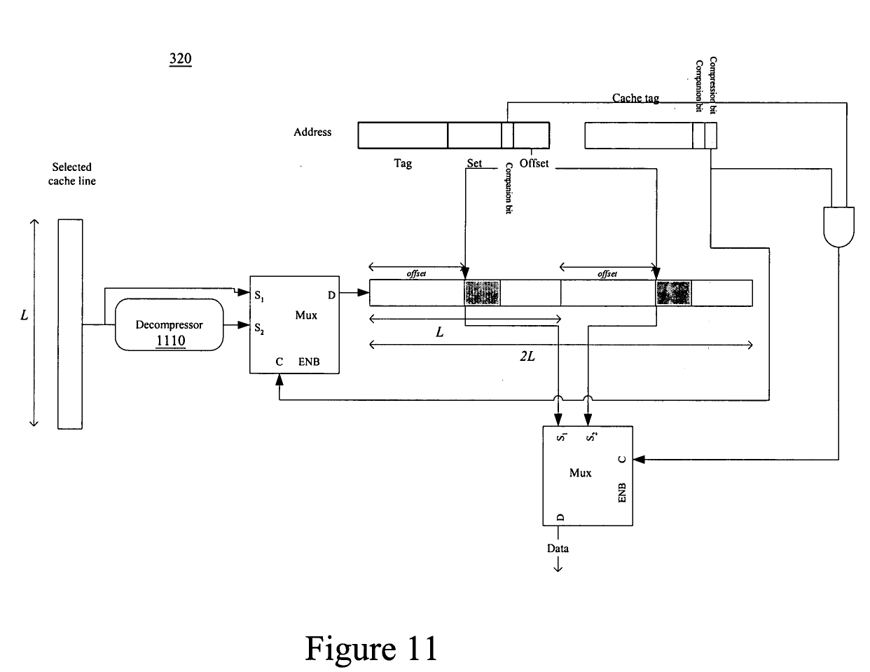

Referring back to FIG. 6, byte selection logic 620 selects the addressed datum within a line. According to one embodiment, byte selection logic 620 depends on the compression bit. FIG. 11 illustrates one embodiment of byte selection logic 620. Byte selection logic 620 includes a decompressor 1110 to decompress a selected cache line if necessary. An input multiplexer selects between a decompressed cache line and an uncompressed cache line depending upon the compression bit.

In one embodiment, the range of the offset depends on whether the line is compressed. If the line is compressed, the companion bit of the address is used as the high order bit of the offset. If the line is not compressed, decompressor 1110 is bypassed and the companion bit of the address is not used for the offset. The selected line is held in a buffer whose size is twice the physical line size to accommodate compressed data.

Alternative embodiments may choose to use the companion bit to select which half of the decompressed word to store in a buffer whose length is the same as the physical line size. However, buffering the entire line is convenient for modifying and recompressing data after writes to the cache.

Referring back to FIG. 6, compression logic 630 is used to compress cache lines. In one embodiment, cache lines are compressed according to a Lempel-Ziv compression algorithm. However in other embodiments, other compression algorithms (e.g., WK, X-Match, sign-bit compression, run-length compression, etc.) may be used to compress cache lines.

Compression logic 630 may also be used to determine when a line is to be compressed. According to one embodiment, opportunistic compression is used to determine when a line is to be compressed. In opportunistic compression, when a cache miss occurs the demanded cache line is fetched from memory 115 and cache 103 attempts to compress both companions into one line if its companion line is resident in the cache. If the companion line is not resident in cache 103 or if the two companions are not compressible by 2:1, then cache 103 uses its standard replacement algorithm to make space for the fetched line.

Otherwise, cache 103 reuses the resident companion's cache line to store the newly compressed pair of companions thus avoiding a replacement. Note, that it is easy to modify the tag match operator to check whether the companion line is resident without doing a second cache access. For example, if all of the address tag bits except for the companion bit match, then the companion line is resident.

In another embodiment, a prefetch mechanism is used to determine if lines are to be compressed. In the prefetch compression mechanism the opportunistic approach is refined by adding prefetching. If the companion of the demand-fetched line is not resident, the cache prefetches the companion and attempts to compress both companions into one line.

If the two companion lines are not compressible by 2:1, cache 103 has the choice of either discarding the prefetched line (thus wasting bus bandwidth) or storing the uncompressed prefetched line in the cache (thus potentially resulting in a total of two lines to be replaced in the set). In one embodiment, the hardware can adaptively switch between these policies based on how much spatial locality and latency tolerance the program exhibits.

In another embodiment, a victim compression mechanism is used to determine if lines are to be compressed. For victim compression, there is an attempt to compress a line that is about to be evicted (e.g., a victim). If a victim is not already compressed and its companion is resident, cache 103 gives the victim a chance to remain resident in the cache by attempting to compress it with its companion. If the victim is already compressed, its companion is not resident, or the victim and its companion are not compressible by 2:1, the victim is then evicted. Otherwise, cache 103 reuses the resident companion's cache line to store the compressed pair of companions, thus avoiding the eviction.

As data is written, the compressibility of a line may change. A write to a compressed pair of companions may cause the pair to be no longer compressible. Three approaches may be taken if a compressed cache line becomes uncompressible. The first approach is to simply evict another line to make room for the extra line resulting from the expansion. This may cause two companion lines to be evicted if all lines in the set are compressed.

The second approach is to evict the companion of the line that was written. The third approach is to evict the line that was written. The choice of which of these approaches to take depends partly on the interaction between the compressed cache 103 and the next cache closest to the processor (e.g., if the L3 is a compressed cache then it depends on the interaction between L3 and L2).

Assuming that the compressed cache is an inclusive L3 cache and that L2 is a write-back cache, the first two approaches include an invalidation of the evicted line in the L2 cache to maintain multi-level inclusion, which has the risk of evicting a recently accessed cache line in L2 or L1. The third approach does not require L2 invalidation and does not have the risk of evicting a recently accessed cache line from L2 because the line that is being written is being evicted from L2.

The above-described mechanism allows any two cache lines that map to the same set and that differ only in their companion bit to be compressed together into one cache line. In one embodiment, the mechanism modifies the set mapping function and selects the companion bit such that it allows adjacent memory lines to be compressed together, which takes advantage of spatial locality.

Increasing Cache Compressibility

The above-described cache compression mechanism typically involves some integral factor to compress data. For example, data is compressed by 2:1, 3:1, 4:1 factors. The motivation for the integral factor is to simplify tag matching (e.g., to use a match on tag bits, rather than an arithmetic range check). Matching tag bits entails the tag-addressable contents of the cache corresponding to some power of two number of bytes.

Further, typical cache line sizes are influenced by addressing constraints to also include some power of two number of bytes. Usually, cache line size and tag-addressable line size are equal. In the case of a compressed cache, line size and tag-addressable line size may not match. However, simplifying tag matching, and a desire to minimize addressing constraints results in the integral compressibility constraint.

Restricting compressibility to 50% (2:1) compression is a strategy, which penalizes those pairs of lines that are compressible by 49% and 5% equally. In other words, both cases will be treated as uncompressible. Adding 10 bytes per line allows the compression of 90% of resident cache lines. According to one embodiment, additional bytes are added for each cache line, resulting in the capability of compressing a line that are not quite 50% (or 33%, 25%, etc.) compressible.

In a further embodiment, additional bytes are available on demand from a separate pool. Thus, obviating any requirement of extending each physical cache line to accommodate some number of extra bytes.

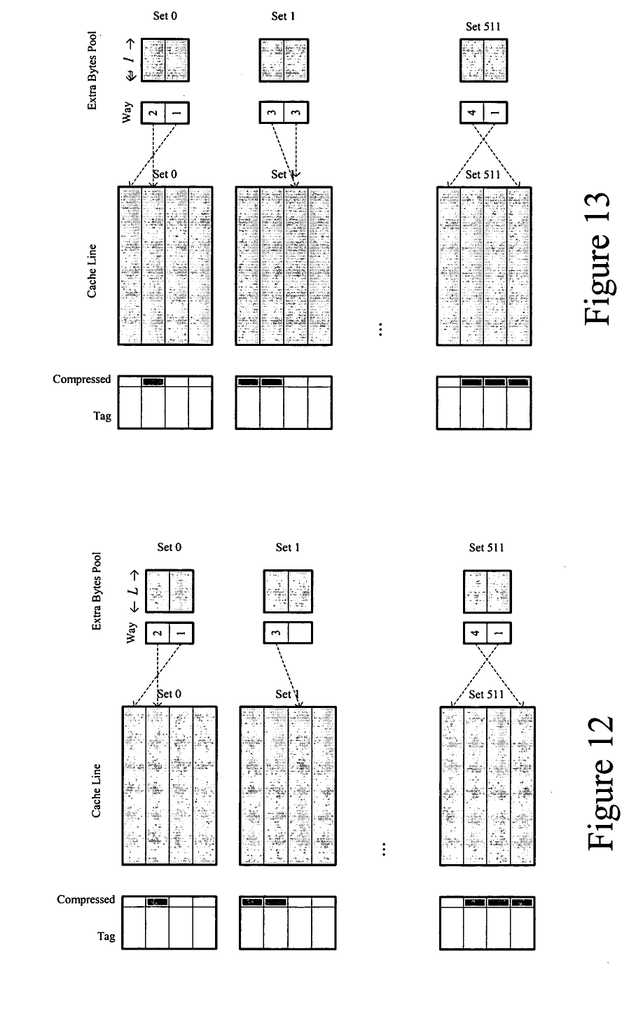

FIG. 12 illustrates one embodiment of a pool of bytes cache. Each pool of bytes cache is a smaller cache that hold additional bytes for lines that are to be compressed, but does not have sufficient space to compress. In one embodiment, the pool of bytes has a fixed width of multiple bytes. In addition, a pool is allocated to ways of each set. For instance, cache set 0, cache set 1, and so on, each include an allocated pool.

In another embodiment, a way indicator is associated with every line of each extra bytes pool. The way indicator points to the way to which a particular extra byte field is assigned. Note that no more than two ways are required for each set since not every cache line in a set will need additional bytes. The pool of bytes scheme disclosed in FIG. 12 has the advantage of requiring only one additional lookup in the byte pool per line.

FIG. 13 illustrates another embodiment of a pool of bytes cache. In this embodiment, the width of the pools are fixed (tough finer grained, e.g. one byte), and many pool entries may map to each way. For example, both bytes in set 1 map to way 3 of the cache. In one embodiment, the ordering of bytes is handled so that each byte field mapped to a particular set is sorted accordingly with respect to the logical ordering in the extended cache line. In this way, lookups should proceed serially through the byte pool finding matches in order until no further matches are found.

In a further embodiment, an associated LRU state for each pool entry is inherited from the owning way. Note that a replacement in the main cache may displace additional lines. In a one-to-one byte field mapping, an additional line may be displaced if the byte pool entry is required by a new line. As such, the replacement policy considers both the length of the extended line with the LRU state so that multiple lines are not replaced.

Moreover, a many-to-one byte field mapping is further complicated by the variable length nature of each extended lines byte pool allocation. Multiple lines may need to be displaced. In addition, in the many-to-one mapping case, the replacement policy ensures that all byte entries mapping to the same set are discarded when one is discarded.

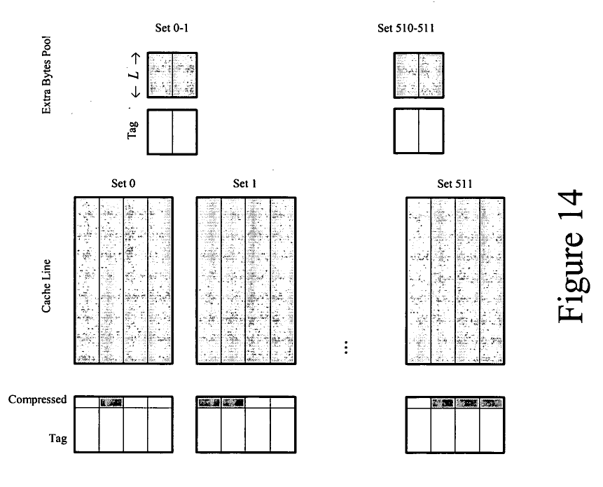

FIG. 14 illustrates another embodiment of a pool of bytes cache. In this embodiment, a pool of bytes may be shared amongst multiple sets. As shown, for example, sets 0 and 1 share a pool. According to one embodiment, a different hashing function for set mapping into the extra byte pool may be accommodated. The simplest hashing modification is to divide the cache's set count by a power of two so that the set hashing for byte pool is a subset of the bits used for the main cache's set lookup. In one embodiment, a set indication is implemented, instead of a way indication to determine ownership. In a further embodiment, the tag is to be stored.

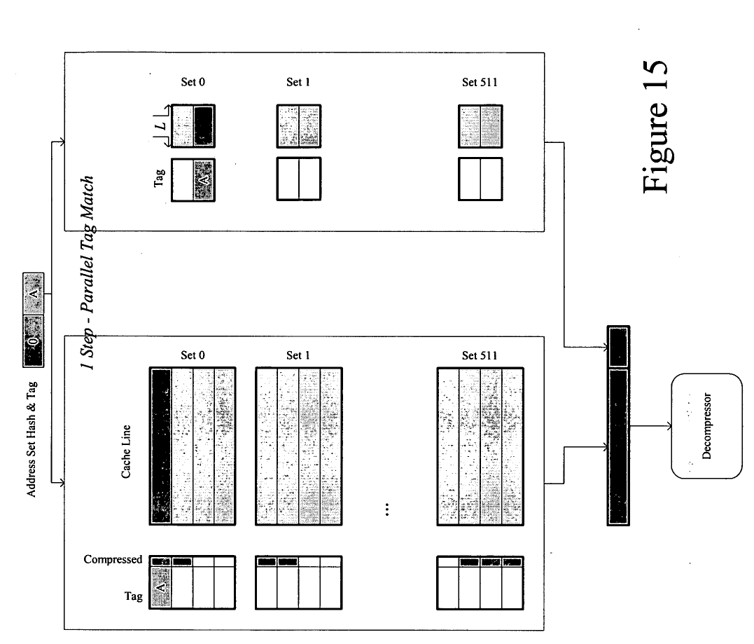

FIG. 15 illustrates one embodiment of a parallel cache lookup scheme. The parallel lookup scheme may be used for the one-to-one mapping allocation policy. In a parallel lookup, set bits are simultaneously dispatched to the main cache and the byte pool cache. The results are appended together and simultaneously fed into the decompression logic.

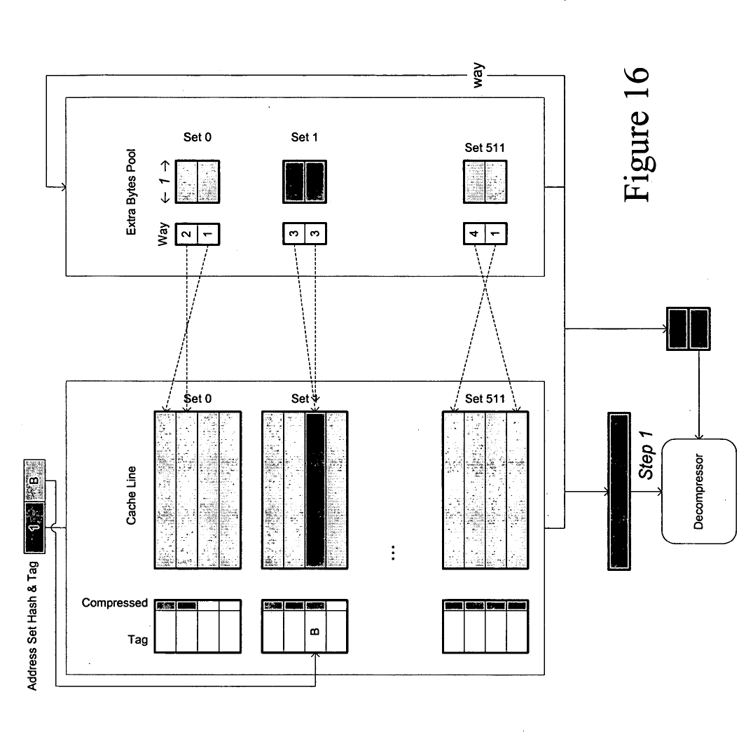

FIG. 16 illustrates one embodiment of a serial cache lookup scheme. The serial lookup scheme may be used for each of the mapping allocation policies. For the serial lookup, the first byte pool cache match can be overlapped with the main cache lookup. Subsequent matches are serialized due to the dependence of placement in the extended line on lookup order.

The pool of bytes implementation increases the potential compressibility of cache contents.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as the invention.

1. A computer system comprising:
a central processing unit (CPU); and
a cache memory, coupled to the CPU, including:
a main cache having a plurality of cache lines that are compressible to store additional data; and
a plurality of storage pools to hold a segment of the additional data for one or more of the plurality of cache lines that are to be compressed.

2. The computer system of claim 1 wherein each of the plurality of storage pools include a plurality of fixed width storage fields.

3. The computer system of claim 1 wherein the plurality of cache lines are included within a plurality of sets.

4. The computer system of claim 3 wherein a storage pool is allocated to each of the plurality of sets.

5. The computer system of claim 4 wherein an indicator is associated with each storage field of a storage pool to indicate a line within one of the plurality of sets to which a storage field is assigned.

6. The computer system of claim 3 wherein multiple storage fields within each storage pool is allocated a within one of the plurality of sets.

7. The computer system of claim 6 wherein each storage field mapped to one of the plurality of sets is sorted according to a logical ordering.

8. The computer system of claim 3 wherein a storage pool is shared by two or more of the plurality of sets.

9. The computer system of claim 8 wherein an indicator is associated with each line of a storage pool to indicate which of the plurality of sets to which a storage field is assigned.

10. The computer system of claim 1 further comprising a cache controller coupled to the cache memory.

11. The computer system of claim 10 wherein the cache controller accesses the cache lines and storage pools in parallel.

12. The computer system of claim 11 wherein accessing the cache lines and storage pools in parallel comprises the cache controller simultaneously dispatching set bits to the cache lines and storage pools.

13. The computer system of claim 11 wherein the cache controller accesses the cache lines and storage pools serially.

14. The computer system of claim 3 wherein a storage pool is shared by all of the plurality of sets.

15. A cache memory comprising:
a main cache having a plurality of cache lines that are compressible to store additional data; and
a plurality of storage pools to hold a segment of the additional data for one or more of the plurality of cache lines that are to be compressed.

16. The cache memory of claim 15 wherein each of the plurality of storage pools include a plurality of fixed width storage fields.

17. The cache memory of claim 15 wherein the plurality of cache lines are included within a plurality of sets.

18. The cache memory of claim 17 wherein a storage pool is allocated to each of the plurality of sets.

19. The cache memory of claim 18 wherein an indicator is associated with each storage field of a storage pool to indicate a line within one of the plurality of sets to which a storage field is assigned.

20. The cache memory of claim 17 wherein multiple storage fields within each storage pool is allocated a line within one of the plurality of sets.

21. The cache memory of claim 17 wherein a storage pool is shared by two or more of the plurality of sets.

22. The cache memory of claim 21 wherein an indicator is associated with each line of a storage pool to indicate which of the plurality of sets to which a storage field is assigned.

23. The cache memory of claim 17 wherein a storage pool is shared by all of the plurality of sets.

24. A method comprising:
compressing one or more of a plurality of cache lines to store additional data by:
storing a first component of the data in a main cache; and
storing a second component of the data in one or more of a plurality of storage pools.

25. The method of claim 24 wherein the plurality of cache lines are included within a plurality of sets.

26. The method of claim 25 further comprising allocating a storage pool to each of the plurality of sets.

27. The method of claim 26 further comprising associating an indicator with each storage field of a storage pool to indicate a line within one of the plurality of sets to which a storage field is assigned.

28. The method of claim 25 further comprising allocating a storage pool to a line within one of the plurality of sets.

29. The method of claim 28 further comprising mapping each storage field to one of the plurality of sets.

30. The method of claim 29 further comprising associating an indicator with each line of a storage pool to indicate which of the plurality of sets to which a storage field is assigned.

31. A computer system comprising:
a central processing unit (CPU); and
a cache memory, coupled to the CPU, including:
a main cache having a plurality of cache lines that are compressible to store additional data; and
a plurality of storage pools to hold a segment of the additional data for one or more of the plurality of cache lines that are to be compressed; and
a main memory device coupled to the CPU.

32. The computer system of claim 31 wherein each of the plurality of storage pools include a plurality of fixed width storage fields.

33. The computer system of claim 31 wherein the plurality of cache lines are included within a plurality of sets.
